(19) United States
(12) Patent Application Publication
(10) Pub. No.: US 2025/0203548 A1
(43) Pub. Date: Jun. 19, 2025

(54) METHODS AND APPARATUSES FOR MEAN EPHEMERIS FOR DISCONTINUOUS COVERAGE

(71) Applicant: LENOVO (BEIJING) LIMITED, Beijing (CN)

(72) Inventors: Min Xu, Beijing (CN); Lianhai Wu, Beijing (CN); Jing Han, Beijing (CN); Ran Yue, Beijing (CN); Jie Hu, Beijing (CN)

(21) Appl. No.: 18/842,932

(22) PCT Filed: May 20, 2022
(86) PCT No.: PCT/CN2022/094110

§ 371 Date: Aug. 30, 2024

(51) Int. Cl. H04W 56/00; H04B 7/185; H04W 48/08

(52) U.S. Cl. CPC H04W 56/0045; H04B 7/18513; H04W 48/08

(57) ABSTRACT

The present application relates to methods and apparatuses for a mean ephemeris for discontinuous coverage. One embodiment of the present disclosure provides a user equipment (UE) may include a transceiver; and a processor coupled with the transceiver and configured to: receive, with the transceiver, a first configuration message including a first configuration and a first mean ephemeris; and identify the first mean ephemeris in the first configuration message based on the first configuration.

### TECHNICAL FIELD

The present disclosure relates to 3^{rd} generation partnership project (3GPP) 5G wireless communication technology, especially to methods and apparatuses for a mean ephemeris for discontinuous coverage.

### BACKGROUND OF THE INVENTION

In a network with discontinuous coverage, the UE may be located in the area or in the time period with no available serving cell. The UE may be provided with information for discontinuous coverage, wherein multiple types of information, for example, the mean ephemeris, or the instantaneous, may be provided with the same format or different formats in the same message.

Therefore, it is advantageous to provide solutions for providing and for identifying information for discontinuous coverage, more specifically, it is advantageous to provide solutions for providing and identifying a mean ephemeris for discontinuous coverage.

### SUMMARY

One embodiment of the present disclosure provides a user equipment (UE) may include a transceiver; and a processor coupled with the transceiver and configured to: receive, with the transceiver, a first configuration message including a first configuration and a first mean ephemeris; and identify the first mean ephemeris in the first configuration message based on the first configuration.

In some embodiments, the first configuration message includes a system information block (SIB) dedicated for discontinuous coverage or a dedicated signalling message for discontinuous coverage.

In some embodiments, the first configuration includes at least one of the following: an ephemeris type indication indicating at least one ephemeris type; at least two information elements, wherein each information element is dedicated for one ephemeris type; a validity time for the first mean ephemeris; an epoch time associated with the first mean ephemeris; an averaged time duration associated with the first mean ephemeris; a start serving time associated with the first mean ephemeris; one or more identifiers of radio access network (RAN) nodes associated with the first mean ephemeris; an identifier of a group of RAN nodes associated with the first mean ephemeris; or a format for the first mean ephemeris.

In some embodiments, the format includes at least one of a simplified general perturbations 4 (SGP4) format ephemeris or a two line elements (TLE) format ephemeris.

In some embodiments, the processor is further configured to identify the first mean ephemeris based on at least one of the following condition being met: the ephemeris type indication indicates a mean ephemeris type; an information element of the at least two information elements indicates that a mean ephemeris is included in the first configuration message; a value of the validity time is larger than a first threshold; a unit of the epoch time is larger than a second threshold; a unit of the epoch time is in second; the epoch time is a time offset of a beginning of a current day or a current week; the start serving time is a time offset of the beginning of the current day or the current week; the averaged time duration is included in the first configuration; the two or more identifiers of RAN nodes is included in the first configuration; the identifier of a group of RAN nodes is included in the first configuration; or a format of an ephemeris included in the first configuration message corresponds to the format for the first mean ephemeris; a format of an ephemeris included in the first configuration message is in a simplified general perturbations 4 (SGP4) format ephemeris or a two line elements (TLE) format.

In some embodiments, the processor is further configured to apply at least a part of the first configuration to the first mean ephemeris for discontinuous coverage, wherein applying the at least a part of the first configuration includes at least one of the following: determining the first mean ephemeris is valid before the validity time; applying the epoch time to the first mean ephemeris; determining the first mean ephemeris is a mean ephemeris during the averaged time duration; determining the first mean ephemeris is associated with one or more RAN nodes with the one or more identifiers; or determining the first mean ephemeris is associated with a group of RAN nodes with the identifier of a group of RAN nodes.

In some embodiments, the processor is further configured to: maintain a validity timer for the first mean ephemeris, wherein the validity timer is started at the epoch time and expires at the validity time.

In some embodiments, the processor is further configured to acquire a second configuration and a second mean ephemeris in response to at least one of the following: a second configuration message for updating a mean ephemeris being received; a validity timer for the first mean ephemeris being expired; a predicted interruption period of network coverage has passed; waking up from a power saving mode after an interruption of network coverage; selecting or reselecting to a cell after an interruption of network coverage; completing random access to a cell after an interruption of network coverage; or identifying the first mean ephemeris in the first configuration message being failed.

In some embodiments, the processor is further configured to: transmit a request for the second mean ephemeris to a base station (BS) and receive the second configuration and the second mean ephemeris in a dedicated signaling; or receive a system information block including the second configuration and the second mean ephemeris.

In some embodiments, the processor is further configured to perform at least one of the following: predict coverage discontinuity based on the first mean ephemeris; disable neighbour cell measurement triggering; or stop on-going measurement for neighbour cells.

In some embodiments, the processor is further configured to: prioritize, deprioritize, or preclude a neighbour cell in a cell reselection evaluation procedure based on a mean ephemeris from the neighbour cell.

Another embodiment of the present disclosure provides a BS may include a transceiver; and a processor coupled with the transceiver and configured to: generate a first configuration message including a first configuration and a first mean ephemeris; and transmit, with the transceiver, the first configuration message.

In some embodiments, the first configuration message includes a SIB dedicated for discontinuous coverage or a dedicated signalling message for discontinuous coverage.

In some embodiments, the first configuration includes at least one of the following: an ephemeris type indication indicating at least one ephemeris type; at least two information elements, wherein each information element is dedicated for one ephemeris type; a validity time for the first mean ephemeris; an epoch time associated with the first mean ephemeris; an averaged time duration associated with the first mean ephemeris; a start serving time associated with the first mean ephemeris; one or more identifiers of RAN nodes associated with the first mean ephemeris; an identifier of a group of RAN nodes associated with the first mean ephemeris; or a format for the first mean ephemeris.

In some embodiments, the format includes at least one of a SGP4 format ephemeris or a TLE format ephemeris.

In some embodiments, the processor is further configured to: receive a request for the second mean ephemeris to a BS and transmit the second configuration and the second mean ephemeris in a dedicated signaling; or transmit a system information block including the second configuration and the second mean ephemeris.

In some embodiments, the processor is further configured to: transmit a second configuration message for updating a mean ephemeris.

Yet another embodiment of the present disclosure provides a method performed by a UE may include receiving a first configuration message including a first configuration and a first mean ephemeris; and identifying the first mean ephemeris in the first configuration message based on the first configuration.

Still another embodiment of the present disclosure provides a method performed by a BS may include generating a first configuration message including a first configuration and a first mean ephemeris; and transmitting the first configuration message.

### BRIEF DESCRIPTION OF THE DRAWINGS

In order to describe the manner in which advantages and features of the application can be obtained, a description of the application is rendered by reference to specific embodiments thereof, which are illustrated in the appended drawings.

These drawings depict only example embodiments of the application and are not therefore to be considered limiting of its scope.

FIG. 1 depicts an NTN network according to some embodiments of the present disclosure.

FIGS. 2A and 2B respectively illustrate two exemplary satellite ephemeris formats according to some embodiments of the present disclosure.

FIG. 3 illustrates a flow chat of methods performed by the UE and the BS for mean ephemeris for discontinuous coverage according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The NTN network refers to networks, or segments of networks using radio frequency resources on board a satellite. The satellite in NTN may include low earth orbiting (LEO) satellites orbiting around the Earth, medium earth orbiting (MEO) satellites, geostationary earth orbiting (GEO) satellites with fixed location to the Earth, as well as highly elliptical orbiting (HEO) satellites. In some scenarios, the satellite in NTN may also include microsatellite platforms (a.k.a. Cube satellites) with limited size and power and low-density satellite constellations, which have restricted link budget and discontinuous coverage where the UE can remain long periods of time without being able to detect a satellite cell.

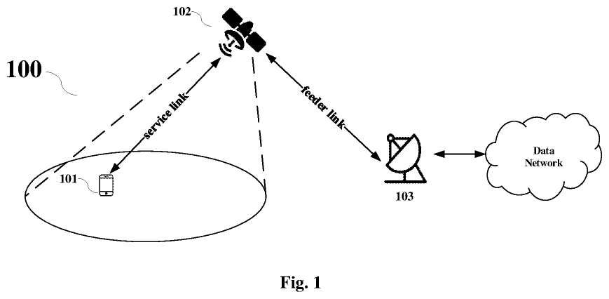

FIG. 1 depicts an NTN network according to some embodiments of the present disclosure.

As shown in FIG. 1, the NTN network 100 includes at least one user equipment (UE) 101 and at least one RAN nodes (e.g., satellite 102), or alternatively a unmanned aerial systems (UAS) platform 102. Although only one UE 101 and a satellite/UAS platform 102 are depicted in FIG. 1, it is contemplated that any number of UEs 101 and satellites/UAS platforms 102 may be included in the wireless communication system 100.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, user terminals, a device, or by other terminology used in the art. The UE 101 may communicate directly with the satellite 102 via the service link.

Satellite 102 may include low earth orbiting (LEO) satellites, medium earth orbiting (MEO) satellites, geostationary earth orbiting (GEO) satellites, as well as highly elliptical orbiting (HEO) satellites. UAS platform(s) 102 may include unmanned aircraft systems (UAS) including tethered UAS and lighter than air UAS (LTA), Heavier than air UAS (HTA), and high altitude platforms UAS (HAPs). Hereinafter in the present disclosure, satellite 102 is used elaborate the technical solution. However, persons skilled in the art can know that the same technique may also be applied to the UAS platform(s).

Referring still to FIG. 1, the satellite 102 provides a geographic cell for serving UE 101 located in the geographic cell. In FIG. 1, UE 101 may be a normal mobile terminal 101, which can wirelessly communicate with the satellite/UAS platform 102 via a communications link, such as service link or radio link in accordance with a NR access technology (e.g., a NR-Uu interface). As also shown in FIG. 1, the satellite 102 also communicates with a gateway 103 or earth station via a communication link, which may be a feeder link or radio link in accordance with NR access technologies or other technologies. In accordance with various embodiments, the satellite 102 may be implemented with either a transparent or a regenerative payload. When the satellite carries a “transparent” payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (i.e., all or part of base station functions (e.g., a gNB, eNB, etc.) are implemented on board. Hereinafter in the present disclosure, satellite 102 may also be referred to as a RAN node 102, which may include a satellite with a regenerative payload or a satellite with a regenerative payload. The RAN node 102 may act as an access node, while in some other embodiments of the present disclosure, the satellite 102 may also act as a BS.

A typical terrestrial communication network includes one or more base stations (typically known as a “BS”) that are located on earth (i.e., not airborne or spaceborne) that each provides geographical radio coverage, and UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

Returning back to FIG. 1, the gateway 103 may be coupled to a data network such as, for example, the Internet, terrestrial public switched telephone network, mobile telephone network, or a private server network, etc. Gateway 103 and the satellite 102 communicate over a feeder link, which includes both a feeder uplink from the gateway 103 to the satellite 102 and a feeder downlink from the satellite 102 to the gateway 103. Although a single gateway 103 is shown, some implementations will include many gateways, such as five, ten, or more. One embodiment includes only one gateway. UE 101 and satellite 102 communicate over a service link, which has both an uplink from the UE 101 to the BS and a downlink from the BS to the UE 101.

In some embodiments, communication within the system of FIG. 1 follows a nominal roundtrip direction whereby data is received by gateway from data network (e.g., the Internet) and transmitted over a forward path to UE 101. In one example, communication over the forward path comprises transmitting the data from gateway to satellite 102 via uplink of the feeder link, through a first signal path on satellite, and from satellite 102 to UE 101 via downlink of the service link. Data can also be sent from UE 101 over a return path to gateway. In one example, communication over the return path may include transmitting the data from UE 101 to satellite 102 via uplink of the service link, through a second signal path on satellite 102, and from satellite 102 to gateway via downlink of the feeder link.

The wireless communication system 100 is compliant with any type of network that is capable of sending and receiving wireless communication signals. For example, the wireless communication system 100 is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3GPP-based network, 3GPP 5G network, a satellite communications network, a high altitude platform network, and/or other communications networks.

In one implementation, the wireless communication system 100 is compliant with the NR of the 3GPP protocol, wherein the BS transmits using an OFDM modulation scheme on the DL and the UE 101 transmits on the UL using a single-carrier frequency division multiple access (SC-FDMA) scheme or OFDM scheme. More generally, however, the wireless communication system 100 may implement some other open or proprietary communication protocol, for example, WiMAX, among other protocols.

In other embodiments, the RAN node (such as satellite 102) may communicate using other communication protocols, such as the IEEE 802.11 family of wireless communication protocols. In some embodiments, the RAN node 102 may communicate over licensed spectrum, while in other embodiments the RAN node 102 may communicate over unlicensed spectrum. The present disclosure is not intended to be limited to the implementation of any particular wireless communication system architecture or protocol. In another embodiment, the RAN node 102 may communicate with the UE 101 using the 3GPP 5G protocols.

In NTN, the discontinuous coverage may happen in space and/or time domain due to sparse constellation of satellites and satellite movement, and the discontinuous coverage may be either cell-specific for a certain area, or UE-specific relating to UE location or UE subscription to operators. It may lead to additional and unnecessary power consumption which is at least essential to internet of things (IoT) devices.

Unlike the temporary coverage interruptions in TN, in NTN the coverage interruptions are expected to last for a longer time duration (for example, the interruptions may last hours) and are predictable with the help of satellite assistance information provided by network to the UE. Ephemeris is the information with multiple parameters to describe satellite orbit, position, movement, or the like. The satellite assistance information in discontinuous coverage prediction, which may include the instantaneous ephemeris of the serving RAN node (e.g. satellite) and/or that of a neighbor RAN node (or the next upcoming RAN node), and the mean ephemeris (or the average ephemeris) of the serving RAN node and/or that of the neighbor RAN node, may be provided to the UE, to improve accuracy of the prediction of the discontinuous coverage. The information for discontinuous coverage may be included in a system information block, such as SIBYY, or SIB32, which may be different from the SIB for IoT NTN.

In NTN especially that with LEO, or fast moving satellites, the ephemeris data is used to indicate the trajectories and position coordinates of the satellite. Serving satellite ephemeris can be indicated to UE to calculate the distance to the satellite and thus the propagation delay can be determined, which is essential for uplink time synchronization in NTN. The ephemeris can also be used to calculate satellite velocity to the UE, which is essential for uplink frequency synchronization. That is the same for the HAPS in NTN.

The instantaneous satellite ephemeris used in NTN may be represented with two satellite ephemeris formats: 1) position and velocity state vector ephemeris format, or 2) orbital parameter ephemeris format.

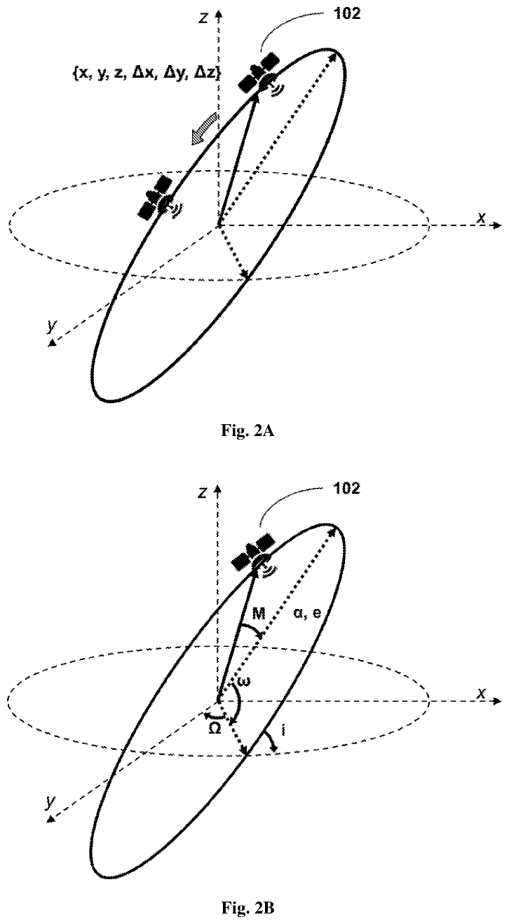

FIGS. 2A and 2B respectively illustrate two satellite ephemeris formats according to some embodiments of the present disclosure. For satellite systems, either one format or both formats may be applied to represent the location of the satellite, while for an HAPS without an orbit as the satellites, only the position and velocity state vector ephemeris format is applied.

Specifically, in FIG. 2A, the satellite 102 is orbiting around the Earth. The origin of the coordinate system is the center of the Earth. The coordinate system has three axes, the x axis, the y axis, and the z axis.

FIG. 2A depicts the position and velocity state vector ephemeris format, wherein, the satellite ephemeris is represented by the position and the velocity state vector {x, y, z, Δx, Δy, Δz}, and
x is the coordinate value on the x-axis;
y is the coordinate value on the y-axis;
z is the coordinate value on the z-axis;
Δx is the velocity value on the x-axis;
Δy is the velocity value on the y-axis; and
Δz is the velocity value on the z-axis.

The payload size for position and velocity state vector ephemeris format is 17 Bytes, i.e. 17×8=136 bits. Within the 136 bits, 78 bits are for position (with the unit of meter (m)), i.e., the parameters {x, y, z}. The position range is determined by GEO with the range from −42200 kilometer (km) to +42200 km. The quantization step is 1.3 m for position. 54 bits are for velocity, with the unit of meter per second (m/s), and the velocity range is determined by LEO@600 km with the range from −8000 m/s to +8000 m/s.

FIG. 2B depicts the orbital parameter ephemeris format. That is, the satellite ephemeris is represented with orbital parameters. In FIG. 2B, the satellite 102 is a GEO satellite with fixed location to the Earth. The origin of the coordinate system is the center of the Earth. The coordinate system has three axes, the x axis, the y axis, and the z axis. The payload size for position and velocity state vector ephemeris format is 18 Bytes, i.e., 18×8=144 bits. The orbital parameters include:
1. Semi-major axis α, the unit of the semi-major axis is m, the bit size for semi-major axis is 33 bits, and the value of a ranges from 6500 km to 43000 km;
2. Eccentricity e, the bit size for eccentricity is 19 bits, and the value of eccentricity is not larger than 0.015, i.e. <0.015;
3. Argument of periapsis ω, the unit of the argument of periapsis is rad, the bit size of argument of periapsis is 24 bits, and the value of ω ranges from 0 to 2π;
4. Longitude of ascending node Ω, the unit of the longitude of ascending node is rad, the bit size of longitude of ascending node is 21 bits, and the value of Ω ranges from 0 to 2π;
5. Inclination i, the unit of inclination is rad, the bit size of the inclination is 20 bits, and the value of i ranges from −π/2 to +π/2;
6. Mean anomaly M at epoch time, the unit the mean anomaly is rad, of the bit size of mean anomaly is 24 bits, and the value of M ranges from 0 to 2π.

For the moving satellites or HAPS, part or all of the parameters in the ephemeris vary over time. With satellite (or HAPS) ephemeris associated with a time point (namely the epoch time) provided, the UE can calculate the satellite (or HAPS) position at current or future time point as long as it is valid. To ensure the accuracy and validity of the calculation, it is necessary to provide the epoch time and the validity time duration of the serving satellite (or HAPS) ephemeris to the UE. Other information related to uplink time synchronization, including the common TA and its changing rate, can also be indicated with the epoch time and the validity time duration to guarantee accuracy and validity of the uplink time synchronization.

For the mean ephemeris, it may use the average orbital parameters as shown in FIG. 2B, or it may also use a different format, such as the TLE format, the SGP4 format, or other formats that are different from the formats for instantaneous ephemeris. For example, an example of ephemeris in the TLE format may be:
“Example (STARLINK-24)
1 44238U 19029D 22110.17352234+0.00059956 00000−0 22428−2 0 9998
2 44238 53.0075 22.2422 0005474 141.6880 218.4507 15.26762826 160969”

Line 1 of the ephemeris in the TLE format includes: “44238U 19029D 22110.17352234+0.00059956 00000−0 22428−2 0 9998”, and Line 2 of the ephemeris in the TLE format includes “44238 53.0075 22.2422 0005474 141.6880 218.4507 15.26762826 160969,” and the meaning of these symbols are represented in the following table:

TABLE 1
TLE ephemeris
Example (STARLINK-24)
1 44238U 19029D 22110.17352234 +.00059956 00000-0 22428-2 0 9998
2 44238 53.0075 22.2422 0005474 141.6880 218.4507 15.26762826 160969

| Line | Column | format | example | meaning |
|---|---|---|---|---|
| 1 | 3~8 | xxxxxY | 44238U | xxxxx as satellite number |
| | | | | (44238) |
| | | | | Y as classification (U as |
| | | | | Unclassified) |
| | 10~17 | xxYYYzzz | 19029D | xx as launch year (19 as |
| | | | | 2019) |
| | | | | YYY as launch serial number |
| | | | | (029 as 29^{th} launch) |
| | | | | zzz as object serial number |
| | | | | (D as the 4^{th} object) |
| | 19~32 | xxYYY.YYYYYYYY | 22110.17352234 | xx as current year (22 as |
| | | | | 2022) |
| | | | | YYY.YYYYYYYY as current |
| | | | | day (110.17352234^{th} day) |
| | 34~43 | x.YYYYYYYY | +.00059956 | x as positive-negative sign |
| | | | | YYYYYYYY as the first time |
| | | | | derivative of mean motion |
| | 45~52 | xYYYYY-z | 00000-0 | x as positive-negative sign |
| | | | | YYYYY-z as the second time |
| | | | | derivative of mean motion |
| | 54~61 | xxxxx-Y | 22428-2 | BSTAR drag term |
| | 63 | x | 0 | orbit type (typical 0) |
| | 65~69 | xxxY | 9998 | xxx as TLE serial number |
| | | | | (999^{th} TLE) |
| | | | | Y as checksum (modulo 10) |
| 2 | 3~7 | xxxxx | 44238 | satellite number (44238) |
| | 9~16 | xx.xxxx | 53.0075 | inclination |
| | 18~25 | xx.xxxx | 22.2422 | longitude of ascending node |
| | 27~33 | xxxxxxx | 0005474 | eccentricity |
| | 35~42 | xxx.xxxx | 141.6880 | periapsis |
| | 44~51 | xxx.xxxx | 218.4507 | anomaly |
| | 53~63 | xx.xxxxxxxx | 15.26762826 | cycles/day |
| | 64~68 | xxxxxY | 160969 | xxxxx as cycle serial number |
| | | | | after launch |
| | | | | Y as checksum (modulo 10) |

In line 2, column 9˜16, the parameter “inclination” has the same meaning as the parameter “i” in the orbital parameter ephemeris format as shown in FIG. 2B.

In line 2, column 18˜25, the parameter “longitude of ascending node” has the same meaning as the parameter “longitude of ascending node Ω” in the orbital parameter ephemeris format as shown in FIG. 2B.

In line 2, column 27˜33, the parameter “eccentricity” has the same meaning as the parameter “Eccentricity e” in the orbital parameter ephemeris format as shown in FIG. 2B.

In line 2, column 35˜42, the parameter “periapsis” has the same meaning as the parameter “argument of periapsis ω” in the orbital parameter ephemeris format as shown in FIG. 2B.

In line 2, column 44˜51, the parameter “anomaly” has the same meaning as the parameter “mean anomaly M” in the orbital parameter ephemeris format as shown in FIG. 2B.

In line 2, column 53˜63, the parameter “cycles/day” can derive the parameter “semi-major axis α” in the orbital parameter ephemeris format as shown in FIG. 2B.

Table 2 below shows the comparison of the instantaneous ephemeris and the mean ephemeris.

TABLE 2
Comparison of instantaneous ephemeris and mean ephemeris

| Ephemeris type | instantaneous ephemeris | mean ephemeris |
|---|---|---|
| co-existence | Both the instantaneous ephemeris and the mean ephemeris may be | |
| | included in the configuration message | |
| Format | position and velocity state | orbital parameter ephemeris |
| | vector ephemeris | other formats (e.g. TLE) |
| | orbital parameter ephemeris | |
| | format | |
| Epoch time | Relative time with granularity of | Absolute time with granularity of |
| | frames or system frame numbers | seconds or minutes (which may |
| | (SFNs) (i.e. milliseconds or less) | need transformation if using TLE |
| | | or other format) |
| Averaged | None | Hours, days, or weeks |
| time duration | | |
| Validity time | with granularity of seconds | with granularity of hours or |
| | or minutes | days |
| | upon expiration UE loses UL | upon expiration UE discards |
| | sync | prediction of coverage |
| | | discontinuity |
| Satellite | None | Need to associate to multiple |
| ID(s) | | satellite/cell IDs or a satellite |
| | | constellation ID of multiple |
| | | satellites, as it contains average |
| | | values. |
| Provision | Only broadcast is supported | Broadcast is supported in the |
| | serving cell instantaneous | configuration message, which |
| | ephemeris may be included in | may include SIBYY (SIB32) |
| | one or more configuration | Dedicated signalling (request |
| | messages, which may include: | mechanism) |
| | SIBXX (SIB31), SIBYY (SIB32) | |
| | neighbor cell instantaneous | |
| | ephemeris may be included in | |
| | one or more configuration | |
| | messages, which may include: | |
| | SIB2~4, SIBXX (SIB31), SIBYY | |
| | (SIB32) | |
| cell | No impact | Prioritized reselection based on |
| reselection | | presence of the configuration |
| | | message (e.g. SIBYY (SIB32)) |
| | | and mean ephemeris |
| disabling | No impact | Can be disabled based on |
| measurement | | presence of the configuration |
| or its | | message (e.g. SIBYY (SIB32)) |
| triggering | | and mean ephemeris |

In conclusion, the BS (or the network) may signal two types of ephemeris to the UE, the instantaneous ephemeris and the mean ephemeris. The mean ephemeris parameters may be transmitted with the same format (e.g., the orbital parameter ephemeris format with 18 Byte payload) as the instantaneous ephemeris in the same configuration message, or with different formats (e.g. the TLE format as shown in the above table 1, a SGP4 format, or other formats).

The UE may always assume there are mean ephemeris and it is up to the network implementation to derive the mean ephemeris (and any trade-off between the instantaneous ephemeris and the mean ephemeris).

At UE side, in the received configuration message, the instantaneous ephemeris and the mean ephemeris may both be represented with the orbital parameter ephemeris format as shown in FIG. 2B, and may both be included in the same configuration message, e.g. SIBYY. Therefore, the UE needs to identify the mean ephemeris in the configuration message for discontinuous coverage prediction. Furthermore, the UE may also need to know when to acquire or re-acquire the mean ephemeris in the case that the mean ephemeris is updated, or expired. The UE behaviors depending on presence or absence of the configuration message and mean ephemeris in the configuration message may need to be specified for prediction.

As a dedicated SIB for discontinuous coverage scenario in IoT NTN, the presence or absence of the dedicated SIB itself could reveal coverage situation from network perspective (e.g. discontinuous coverage or continuous coverage). If the dedicated SIB is present, the presence or absence of the mean ephemeris in it could also reveal more details of coverage discontinuity (e.g. discontinuous coverage common for all UEs in a cell or just for specific UEs). UE behaviors may need to be specified or enhanced based on the presence or absence of the new SIB or a mean ephemeris in the new SIB, including whether the UE can trigger dedicated mechanisms designed for discontinuous coverage, whether the UE can request for UE-specific assistance information to predict coverage discontinuity, whether the UE can select a cell with discontinuous or continuous coverage, or whether UE needs to align with network about the coverage discontinuity. These behaviors are related to the reception of the new SIB and possibly the reception of mean ephemeris in the dedicated SIB.

In particular, a prediction derived from the mean ephemeris may be more accurate, and from implementation perspective, a UE may need to transform the received mean ephemeris to a common format, e.g., TLE. Furthermore, as TLE format includes more information of satellite ephemeris, it may be possible to support provisioning the mean ephemeris in the TLE format.

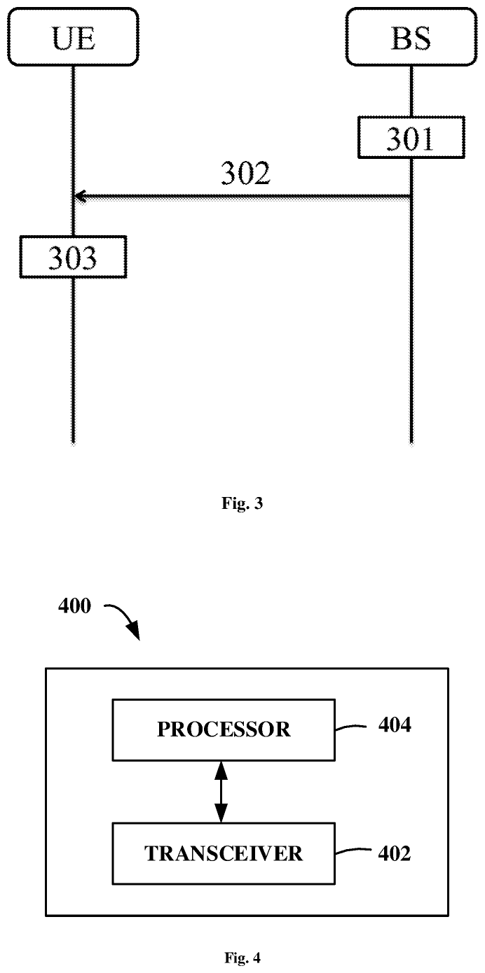

FIG. 3 illustrates a flow chat of methods performed by the UE and the BS for mean ephemeris for discontinuous coverage according to some embodiments of the present disclosure.

In operation 301, the BS may generate a first configuration message, which may be dedicated for discontinuous coverage. The first configuration message may include a first configuration and a first mean ephemeris. The first configuration message may be a system information block, for example, SIBYY (also known as SIY32), or a dedicated signalling, such as a RRC signaling, which includes the first configuration for the first mean ephemeris for discontinuous coverage, and also includes the first mean ephemeris for discontinuous coverage. The first mean ephemeris may be associated with the serving RAN node, a neighbour RAN node (or an upcoming RAN node), one or more RAN nodes, or a group of RAN nodes, or the like.

The first configuration for the mean ephemeris may include at least one of the following:
1. An ephemeris type indication, which indicates one or more types of ephemeris as follows:
   Case 1-1: the ephemeris type indication may include a 1-bit indication, and indicates two types of ephemeris of the serving RAN node (or a neighbour RAN node) as follows:
      One value (for example, “0”) may indicate an instantaneous ephemeris; and
      The other value (for example, “1”) may indicate a mean ephemeris.
   For 1-bit indication, whether it is associated with the serving RAN node or the neighbour RAN node is based on configuration, pre-configuration, or default configuration, or the like.
   Case 1-2: the ephemeris type indication may include a 2-bit indication, and indicates three types of ephemeris as follows:
      The first value (for example, “00”) may indicate an instantaneous ephemeris of a neighbour RAN node;
      The second value (for example, “01”) may indicate a mean ephemeris of the serving RAN node; and
      The third value (for example, “10”) may indicate a mean ephemeris of the neighbour RAN node.
   Regarding the instantaneous ephemeris of the serving neighbour RAN node, it may be indicated to the UE in another configuration message, such as SIB1.
   Case 1-3: the ephemeris type indication may include a 2-bit indication, and indicate four types of ephemeris as follows:
      The first value (for example, “00”) may indicate an instantaneous ephemeris of a neighbour RAN node;
      The second value (for example, “01”) may indicate a mean ephemeris of the serving RAN node;
      The third value (for example, “10”) may indicate a mean ephemeris of the neighbour RAN node; and
      The fourth value (for example, “11”) may indicate an instantaneous ephemeris of the serving RAN node.
2. At least two information elements, each information element is dedicated for one ephemeris type.
   Case 2-1: two information elements are included, the first information element corresponds to the instantaneous ephemeris of the serving RAN node (or a neighbour RAN node), and the second information element corresponds to the mean ephemeris of the serving RAN node (or a neighbour RAN node).
   Case 2-2: three information elements are included, the first information element corresponds to the instantaneous ephemeris of a neighbor RAN node, the second information element corresponds to the mean ephemeris of the serving RAN node, and the third information element corresponds to the mean ephemeris of the neighbour RAN node.
   Case 2-3: four information elements are included, the first information element corresponds to the instantaneous ephemeris of a neighbor RAN node, the second information element corresponds to the mean ephemeris of the serving RAN node, the third information element corresponds to the mean ephemeris of the neighbour RAN node; and the fourth information element corresponds to the instantaneous ephemeris of a serving RAN node.
   Each information element may include one bit, and one value of the bit may indicate a presence of a corresponding ephemeris in the first configuration message, while the other value may indicate a corresponding ephemeris is not included in the first configuration message. For example, for case 2-1, the first information element may include 1 bit, one value of the bit indicates that the instantaneous ephemeris of the serving RAN node is included in the first configuration message, the other value of the bit indicates that the instantaneous ephemeris of the serving RAN node is not included in the first configuration message. Similarly, the second information element may also include 1 bit, one value of the bit indicates that the mean ephemeris of the serving RAN node is included in the first configuration message, the other value of the bit indicates that the mean ephemeris of the serving RAN node is not included in the first configuration message.
3. A validity time of the first mean ephemeris.
   The validity time of the first mean ephemeris may indicate how long the first mean ephemeris may be considered as valid. In other words, the first mean ephemeris stays valid until the validity time.
   Compared with the value (or granularity) of the validity time of an instantaneous ephemeris, which may be represented with the unit such as seconds or minutes, the value (or granularity) of the validity time of the first mean ephemeris may be represented with much longer units, such as hours or days.
   In the case that the first configuration does not include the validity time of the first mean ephemeris, which may suggest that the first mean ephemeris could be considered as valid until the next update.
4. An epoch time associated with the first mean ephemeris.
   The epoch time may indicate the time point or time duration associated to the first mean ephemeris. Similarly, compared with the value (or granularity) of the epoch time associated with an instantaneous ephemeris, which may be represented with the unit such as frames or subframes, the value (or granularity) of the epoch time associated with the first mean ephemeris may be represented with much longer units, such as seconds or minutes.
   In the case that the first configuration does not include the epoch time associated with the first mean ephemeris, which may suggest that the time point of receiving the first configuration message may be considered as the epoch time associated with the first mean ephemeris. Alternatively, the epoch time associated with the instantaneous ephemeris may be used as the epoch time associated with the first configuration.
5. An averaged time duration associated with the first mean ephemeris.
   The averaged time duration may refer to a time duration in which the parameter values of the mean ephemeris are averaged. For example, the time duration may be the last day, the last week, the last month, etc.
6. A start serving time associated with the first mean ephemeris.
   The start serving time may refer to the start serving time from when one or more RAN nodes may provide services to the UE, and the one or more RAN nodes may be associated with the first mean ephemeris.
7. A future time duration associated with the first mean ephemeris.
   The future time duration may refer to a time duration in which the parameter values of the mean ephemeris are predicted. For example, the time duration may be the next day, the next week, the next month, etc.
8. IDs of multiple RAN nodes associated to the first mean ephemeris.
   The IDs of multiple RAN nodes, such as satellites including a satellite 102 in FIG. 1, and the parameters of the first mean ephemeris are associated with the multiple satellites. The number of the multiple RAN nodes may be an integer equal to or larger than one.
9. An ID of a group of RAN nodes associated to the first mean ephemeris.
   For example, an ID of a group of RAN nodes (e.g. satellites), and the parameters of the first mean ephemeris are associated with the group of satellites. The group of satellites may include satellites in a satellite constellation. The number of RAN nodes included in the group of RAN nodes may be an integer equal to or larger than one.
10. A format for the first mean ephemeris.
   The first mean ephemeris may be represented with the TLF format, or SGP4 format, or other formats.

In operation 302, the BS may transmit the first configuration message which includes the first configuration and the first mean ephemeris. In some embodiments, the BS may transmit the first configuration message in the SIB, such as SIBYY (i.e. SIB32), that is, the BS may broadcast the first configuration message in the SIB. In some other embodiments, the first configuration message may be the dedicated signalling for discontinuous coverage for the UE. For example, the BS may transit the first configuration message upon receiving a request for the first configuration message from the UE, as a response, the BS may transmit the dedicated signalling to the UE.

In operation 303, after receiving the first configuration message which includes the first configuration and the first mean ephemeris, the UE may identify the first mean ephemeris in the first configuration message based on the first configuration.

Specifically, the UE may identify the first mean ephemeris as follows:
1. The UE may identify the first mean ephemeris based on the ephemeris type indication.
   For the above case 1-1, that is, the first configuration includes a 1-bit ephemeris type indication. In the case that the 1-bit ephemeris type indication indicates a mean ephemeris of the serving RAN node (or a neighbour RAN node), and the UE may identify the mean ephemeris of the serving RAN node (or a neighbour RAN node). In the case that the 1-bit indication indicates an instantaneous ephemeris of the serving RAN node (or a neighbour RAN node), thus the UE may identify the instantaneous ephemeris of the serving RAN node (or a neighbour RAN node).
   For the above case 1-2, that is, the first configuration includes a 2-bit ephemeris type indication. In the case that the 2-bit indication indicates:
      the first value (for example, “00”) indicating an instantaneous ephemeris of a neighbour RAN node, and the UE may identify an instantaneous ephemeris of a neighbour RAN node in the first configuration message;
      the second value (for example, “01”) indicating a mean ephemeris of the serving RAN node, and the UE may identify the mean ephemeris of the serving RAN node in the first configuration message; and
      the third value (for example, “10”) indicating a mean ephemeris of the neighbour RAN node, and the UE may identify the mean ephemeris of the neighbour RAN node in the first configuration message.
   For the above case 1-3, that is, the first configuration includes a 2-bit ephemeris type indication. In the case that the 2-bit indication indicates:
      the first value (for example, “00”) indicating an instantaneous ephemeris of a neighbour RAN node, and the UE may identify an instantaneous ephemeris of a neighbour RAN node in the first configuration message;
      the second value (for example, “01”) indicating a mean ephemeris of the serving RAN node, and the UE may identify the mean ephemeris of the serving RAN node in the first configuration message;
      the third value (for example, “10”) indicating a mean ephemeris of the neighbour RAN node, and the UE may identify the mean ephemeris of the neighbour RAN node in the first configuration message; and
      the fourth value (for example, “11”) indicating an instantaneous ephemeris of the serving RAN node, and the UE may identify the instantaneous ephemeris of the serving RAN node in the first configuration message.
2. The UE may identify the first mean ephemeris based on the at least two information elements.
   In particular, for each information element in the at least two information elements, the UE may determine the value of the information element, in the case that the value of the information element indicates a presence of a corresponding ephemeris, the UE may identify the corresponding ephemeris in the first configuration message; in the case that the value of the information element indicates corresponding ephemeris is not included in the first configuration message, the UE may not identify the corresponding ephemeris in the first configuration message.
3. The UE may identify the first mean ephemeris based on the validity time of the first mean ephemeris.
   As described above, the value (or granularity) of the validity time of the mean ephemeris may be represented with much longer units.
   A threshold of the validity time may be defined, configured, or preconfigured, and when the value of the validity time is larger than the threshold of the validity time, the UE may consider that the ephemeris associated with the validity time is a mean ephemeris. For instance, the threshold of the validity time may be configured as: one hour.
   For example, if the UE determines the validity time of an ephemeris is one day, which is larger than the threshold, thus the UE may identify that the ephemeris associated with the validity time is the first mean ephemeris.
4. The UE may identify the first mean ephemeris based on a unit of the epoch time.
   As described above, the value (or granularity) of the unit of the epoch time may be represented with much longer units.
   A threshold of the epoch time may be defined, configured, or preconfigured, and when the value of the epoch time is larger than the threshold of the epoch time, the UE may consider that the ephemeris associated with the epoch time is a mean ephemeris. For instance, the threshold of the epoch time may be configured as: one second.
   For example, if the UE determines the epoch time of an ephemeris is one minute, which is larger than the threshold of the epoch time, thus the UE may identify that the ephemeris associated with the epoch time is the first mean ephemeris.
   In some other embodiments, the epoch time may be a time offset of the beginning of the current day or the current week, thus the UE may identify the ephemeris associated with the epoch time is the first mean ephemeris.
5. In the case that the first configuration includes at least one of the following:
   i. the averaged time duration associated with the first mean ephemeris;
   ii. the future time duration associated with the first mean ephemeris;
   iii. the IDs of multiple RAN nodes associated to the mean ephemeris; or
   iv. the ID of a group of RAN nodes associated to the mean ephemeris.
      The instantaneous ephemeris is not associated with the averaged time duration, the future time duration, the IDs of multiple RAN nodes, or the ID of a group of RAN nodes, accordingly, the UE may identify that the ephemeris associated with any of the averaged time duration, the future time duration, the IDs of multiple RAN nodes, or the ID of a group of RAN nodes, is the first mean ephemeris.
6. The UE may identify the first mean ephemeris based on the format for the first mean ephemeris.
   The mean ephemeris may be represented with the TLF format (or the SGP4 format), and the UE may identify an ephemeris as the first mean ephemeris if the ephemeris is represented with the TLF format (or the SGP4 format).
7. The UE may identify the first mean ephemeris based on the start serving time associated with the first mean ephemeris.
   In the case that the start serving time is a time offset of the beginning of the current day or the current week, the UE may determine that the format associated with an ephemeris may be SGP4 format, which may be used by the mean ephemeris, not by the instantaneous ephemeris. Accordingly, the UE may identify the ephemeris associated with the epoch time is the first mean ephemeris.

After identifying the first mean ephemeris, the UE may apply indicated values in the first configuration to the first mean ephemeris. Specifically, the UE may take at least one of the following operations:
1. The UE may apply the validity time to the first mean ephemeris, that is, the UE considers that the first mean ephemeris is valid for discontinuous coverage prediction before the indicated validity time.
2. The UE may apply the epoch time to the first mean ephemeris. Suppose the indicated epoch time is Tₑ, which suggests that the starting validity time of the first mean ephemeris is Tₑ. The time Tₑ may be a time in the past, for example, before the time the UE receives the first configuration message; or a time in the future, for example, after the time the UE receives the first configuration message.
3. Regarding the averaged time duration associated with the first mean ephemeris, the UE may consider that the indicated values of the first mean ephemeris are averaged in the averaged time duration.
4. Regarding the future time duration associated with the first mean ephemeris, the UE may consider that the indicated values of the first mean ephemeris are predicted for the future time duration.
5. Regarding IDs of multiple RAN nodes associated to the mean ephemeris, the UE may consider that the indicated values of the first mean ephemeris are averaged for the multiple RAN nodes.
6. Regarding the ID of a group of RAN nodes associated to the mean ephemeris, the UE may consider that the indicated values of the first mean ephemeris are averaged for the group of RAN nodes.

In some embodiments, the UE may acquire or re-acquire the second mean ephemeris and the associated second configuration. Either the first mean ephemeris or the second mean ephemeris, are mean ephemeris for discontinuous coverage for the UE. However, due to the movement of the RAN nodes, the movement of the UE, and/or the different time, the first mean ephemeris and the second mean ephemeris may be different. In some cases, for example, within the first mean ephemeris is still valid, the first mean ephemeris and the second mean ephemeris may be identical. Similarly, the corresponding first configuration and the corresponding second configuration may be different or the same. The UE may acquire or re-acquire the second mean ephemeris and the associated second configuration in the following cases:
Case 3-1: the UE receives a second configuration message which includes an indication indicating the update of the configuration message for discontinuous coverage, for example, SIBYY or SIY32. The second configuration message may include SIB1 or a paging message, or other messages. Upon receiving the second configuration message, the UE may receive the configuration message, such as SIBYY in the next occasion, and identifies the mean ephemeris (which is different from the previously received mean ephemeris).
Case 3-2: the validity time of the first mean ephemeris received in the first configuration message has passed. That is, the first mean ephemeris is no longer valid, and the UE may acquire or re-acquire the second mean ephemeris and the associated second configuration.
Case 3-3: the UE does not identify any mean ephemeris. For example, the BS may not include the mean ephemeris in the first configuration message. In this case, the UE may acquire or re-acquire the second mean ephemeris and the associated second configuration.
Case 3-4: a predicted interruption period of network coverage has passed. The UE may be in network coverage, and may acquire or re-acquire the second mean ephemeris and the associated second configuration.
Case 3-5: the UE wakes up from power saving mode after an interruption of network coverage. The UE may be in network coverage, and may acquire or re-acquire the second mean ephemeris and the associated second configuration.
Case 3-6: the UE selects or reselects to a cell after an interruption of network coverage. The UE may be in network coverage with the selected or reselected cell, and may acquire or re-acquire the second mean ephemeris and the associated second configuration.
Case 3-7: the UE has completed the random access to a cell after an interruption of network coverage. The UE may have accessed to the network, and may acquire or re-acquire the second mean ephemeris and the associated second configuration.

For a mean ephemeris, such as the first mean ephemeris or the second mean ephemeris, the UE may maintain a validity timer if a validity time is included in the corresponding configuration for the mean ephemeris. Denote the indicated validity time in the configuration as “T” for simplicity.

In the case that the configuration associated with the mean ephemeris also includes the epoch time, Tₑ, and the epoch time Tₑ, is a future time, the UE may start the validity timer for the mean ephemeris at the indicated epoch time, Tₑ, with a length of the indicated validity time T, that is, the validity timer will be started at the indicated future epoch time, Tₑ, and has a length of T. If the epoch time Tₑ, is not a future time, the UE may start the validity timer for the mean ephemeris at reception time of the configuration message, Tᵣ, with a length of the indicated validity time T−Tₑ, that is, the validity timer is started at Tᵣ, and has a length of T−(Tᵣ−Tₑ). When the timer is running, and the UE may not re-acquire the updated mean ephemeris and the corresponding updated mean ephemeris configuration. In the case that the configuration does not include the epoch time, the UE may use the epoch time for the instantaneous ephemeris as the epoch time for the mean ephemeris.

Alternatively, in the case that the configuration associated with the mean ephemeris does not include the epoch time, Tₑ, the UE may consider the reception time of the configuration message as the starting time of the validity timer, and the length of the validity timer is T, that is, the validity timer starts at the reception time, Tᵣ, and has a length of T.

In some embodiments, upon receiving the configuration message for discontinuous coverage (e.g. SIB32) from a serving cell, or a SIB1 from a serving cell that schedules a SIB dedicated for discontinuous coverage (e.g. SIB32), the UE may trigger prediction for coverage discontinuity based on the mean ephemeris for discontinuous coverage included in the configuration message. For example, the UE may calculate the time duration of coverage interruption, the UE may determine the area of coverage discontinuity, or the like. In some embodiments, the UE may disable the neighbour cell measurement triggering in IDLE mode (e.g. RRC IDLE mode), INACTIVE mode (e.g. RRC INACTIVE mode) or CONNECTED mode (e.g. RRC CONNECTED mode). For example, based on the configuration message for discontinuous coverage, the UE determines that there is no neighbour cell, thus the UE may disable the neighbour cell measurement triggering. If the UE is performing the neighbour cell measurement, the UE may stop the on-going measurement for neighbour cells in in IDLE mode (e.g. RRC IDLE mode), INACTIVE mode (e.g. RRC INACTIVE mode) or CONNECTED mode (e.g. RRC CONNECTED mode).

In some other embodiments, after receiving the first configuration message including the first mean ephemeris and the associated first configuration, the UE determines the information associated with discontinuous coverage, which may include: some neighbour cells will continue providing service to the UE, some neighbour cells will stop providing service to the UE, or the like. Based on the information, during a cell reselection evaluation procedure, the UE may prioritize certain neighbour cells, for example, the neighbour cells that will continue providing service to the UE; the UE may deprioritize certain neighbour cells, for example, the neighbour cells that may continue providing service to the UE for a time period; or the UE may preclude the neighbour cell that may stop providing service to the UE.

Correspondingly, at BS side, the BS may generate the configuration message (e.g. the first configuration message) including the mean ephemeris (e.g. the first mean ephemeris) and the associated first configuration (e.g. the first configuration), and broadcast the configuration message in a SIB, or transmit the configuration message to the UE in a dedicated message. In some embodiments, the BS may receive a request from the UE, which requests for a mean ephemeris and its associated configuration. The request may include associated satellite IDs, time duration or UE location information (for example, coordinates, area, country, or other geofences, etc.). The BS then may transmit a response to UE including the requested mean ephemeris and the associated configuration based on the request, for example, the mean ephemeris transmitted to the UE may be associated with the satellite IDs, time duration or UE location information.

FIG. 4 illustrates a simplified block diagram of an exemplary apparatus according to some embodiments of the present disclosure.

As shown in FIG. 4, an example of the apparatus 400 may include at least one processor 404 and at least one transceiver 402 coupled to the processor 404. The apparatus 400 may be a UE or a BS or any other device with similar functions.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE described in any of FIGS. 1-3. In some embodiments of the present disclosure, the apparatus 400 may be a BS. The transceiver 402 and the processor 404 may interact with each other so as to perform the operations of the BS described in any of FIGS. 1-3.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method with respect to the UE as described above. For example, the computer-executable instructions, when executed, cause the processor 404 interacting with transceiver 402 to perform the operations of the UE described in any of FIGS. 1-3.

In some embodiments of the present disclosure, the non-transitory computer-readable medium may have stored thereon computer-executable instructions to cause the processor 404 to implement the method with respect to the BS as described above. For example, the computer-executable instructions, when executed, cause the processor 404 interacting with transceiver 402 to perform the operations of the BS described in any of FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a first configuration message including a first configuration and a first mean ephemeris; and
identify the first mean ephemeris in the first configuration message based on the first configuration.

2. The UE of claim 1, wherein the first configuration message includes a system information block (SIB) dedicated for discontinuous coverage or a dedicated signaling message for discontinuous coverage.

3. The UE of claim 1, wherein the first configuration includes at least one of the following:
an ephemeris type indication indicating at least one ephemeris type;
at least two information elements, wherein each information element is dedicated for one ephemeris type;
a validity time for the first mean ephemeris;
an epoch time associated with the first mean ephemeris;
an averaged time duration associated with the first mean ephemeris;
a start serving time associated with the first mean ephemeris;
one or more identifiers of radio access network (RAN) nodes associated with the first mean ephemeris;
an identifier of a group of RAN nodes associated with the first mean ephemeris; or
a format for the first mean ephemeris.

4. The UE of claim 3, wherein the format includes at least one of a simplified general perturbations 4 (SGP4) format ephemeris or a two line elements (TLE) format ephemeris.

5. The UE of claim 3, wherein the at least one processor is configured to cause the UE to identify the first mean ephemeris based on at least one of the following condition being met:
the ephemeris type indication indicates a mean ephemeris type;
an information element of the at least two information elements indicates that a mean ephemeris is included in the first configuration message;
a value of the validity time is larger than a first threshold;
a unit of the epoch time is larger than a second threshold;
a unit of the epoch time is in second;
the epoch time is a time offset of a beginning of a current day or a current week;
the start serving time is a time offset of the beginning of the current day or the current week;
the averaged time duration is included in the first configuration;
two or more identifiers of RAN nodes is included in the first configuration;
the identifier of a group of RAN nodes is included in the first configuration; or
a format of an ephemeris included in the first configuration message corresponds to the format for the first mean ephemeris;
a format of an ephemeris included in the first configuration message is in a simplified general perturbations 4 (SGP4) format ephemeris or a two line elements (TLE) format.

6. The UE of claim 3, wherein the at least one processor is configured to cause the UE to apply at least a part of the first configuration to the first mean ephemeris for discontinuous coverage, wherein applying the at least a part of the first configuration includes at least one of the following:
determining the first mean ephemeris is valid before the validity time;
applying the epoch time to the first mean ephemeris;
determining the first mean ephemeris is a mean ephemeris during the averaged time duration;
determining the first mean ephemeris is associated with one or more RAN nodes with the one or more identifiers; or
determining the first mean ephemeris is associated with a group of RAN nodes with the identifier of a group of RAN nodes.

7. The UE of claim 3, wherein the at least one processor is configured to cause the UE to:
maintain a validity timer for the first mean ephemeris, wherein the validity timer is started at the epoch time and expires at the validity time.

8. The UE of claim 1, wherein the at least one processor is configured to cause the UE to acquire a second configuration and a second mean ephemeris in response to at least one of the following:
a second configuration message for updating a mean ephemeris being received;
a validity timer for the first mean ephemeris being expired;
a predicted interruption period of network coverage has passed;
waking up from a power saving mode after an interruption of network coverage;
selecting or reselecting to a cell after an interruption of network coverage;
completing random access to a cell after an interruption of network coverage; or
identifying the first mean ephemeris in the first configuration message being failed.

9. The UE of claim 8, wherein the at least one processor is configured to cause the UE to:
transmit a request for the second mean ephemeris to a base station (BS) and receive the second configuration and the second mean ephemeris in a dedicated signaling; or
receive a system information block including the second configuration and the second mean ephemeris.

10. The UE of claim 1, wherein the at least one processor is configured to cause the UE to perform at least one of the following:
predict coverage discontinuity based on the first mean ephemeris;
disable neighbor cell measurement triggering; or
stop on-going measurement for neighbor cells.

11. A base station, comprising:
at least one memory; and
at least one processor coupled with the at least one memory and configured to cause the base station to:
generate a first configuration message including a first configuration and a first mean ephemeris; and
transmit the first configuration message.

12. The base station of claim 11, wherein the first configuration message includes a system information block (SIB) dedicated for discontinuous coverage or a dedicated signaling message for discontinuous coverage.

13. The base station of claim 11, wherein the first configuration includes at least one of the following:
an ephemeris type indication indicating at least one ephemeris type;
at least two information elements, wherein each information element is dedicated for one ephemeris type;
a validity time for the first mean ephemeris;
an epoch time associated with the first mean ephemeris;
an averaged time duration associated with the first mean ephemeris;
a start serving time associated with the first mean ephemeris;
one or more identifiers of radio access network (RAN) nodes associated with the first mean ephemeris;
an identifier of a group of RAN nodes associated with the first mean ephemeris; or
a format for the first mean ephemeris.

14. The base station of claim 13, wherein the format includes at least one of a simplified general perturbations 4 (SGP4) format ephemeris or a two line elements (TLE) format ephemeris.

15. A method performed by a user equipment (UE), the method comprising:
receiving a first configuration message including a first configuration and a first mean ephemeris; and
identifying the first mean ephemeris in the first configuration message based on the first configuration.

16. A processor for wireless communication, comprising:
at least one controller coupled with at least one memory and configured to cause the processor to:
receive a first configuration message including a first configuration and a first mean ephemeris; and
identify the first mean ephemeris in the first configuration message based on the first configuration.

17. The processor of claim 16, wherein the first configuration message includes a system information block (SIB) dedicated for discontinuous coverage or a dedicated signaling message for discontinuous coverage.

18. The processor of claim 16, wherein the first configuration includes at least one of the following:
an ephemeris type indication indicating at least one ephemeris type;
at least two information elements, wherein each information element is dedicated for one ephemeris type;
a validity time for the first mean ephemeris;
an epoch time associated with the first mean ephemeris;
an averaged time duration associated with the first mean ephemeris;
a start serving time associated with the first mean ephemeris;
one or more identifiers of radio access network (RAN) nodes associated with the first mean ephemeris;
an identifier of a group of RAN nodes associated with the first mean ephemeris; or
a format for the first mean ephemeris.

19. The processor of claim 18, wherein the format includes at least one of a simplified general perturbations 4 (SGP4) format ephemeris or a two line elements (TLE) format ephemeris.

20. The processor of claim 18, wherein the at least one controller is configured to cause the processor to identify the first mean ephemeris based on at least one of the following condition being met:
the ephemeris type indication indicates a mean ephemeris type;
an information element of the at least two information elements indicates that a mean ephemeris is included in the first configuration message;
a value of the validity time is larger than a first threshold;
a unit of the epoch time is larger than a second threshold;
a unit of the epoch time is in second;
the epoch time is a time offset of a beginning of a current day or a current week;
the start serving time is a time offset of the beginning of the current day or the current week;
the averaged time duration is included in the first configuration;
two or more identifiers of RAN nodes is included in the first configuration;
the identifier of a group of RAN nodes is included in the first configuration; or
a format of an ephemeris included in the first configuration message corresponds to the format for the first mean ephemeris;
a format of an ephemeris included in the first configuration message is in a simplified general perturbations 4 (SGP4) format ephemeris or a two line elements (TLE) format.
